(19) United States
(12) Patent Application Publication
(10) Pub. No.: US 2025/0016806 A1
(43) Pub. Date: Jan. 9, 2025

(54) RESOURCE CONFLICT AVOIDANCE IN A SIDELINK RESOURCE POOL

(71) Applicant: Robert Bosch GmbH, Stuttgart (DE)

(72) Inventors: Khaled Shawky Hassan, Sarstedt (DE); Maximilian Stark, Hamburg (DE)

(21) Appl. No.: 18/711,651

(22) PCT Filed: Nov. 23, 2021
(86) PCT No.: PCT/EP2021/082628

§ 371 Date: May 20, 2024

(51) Int. Cl. H04W 72/40; H04W 72/25

(52) U.S. Cl. CPC H04W 72/40; H04W 72/25

(57) ABSTRACT

A method for physical resource conflict avoidance when transmitting at least one position reference signal in a radio communication system comprising a first radio node and at least a second radio node. The method includes transmitting, from a second radio node to the first radio node, a position reference signal request, obtaining, at a first radio node, an initial position reference signal including resource elements arranged in a predetermined pattern within a side link position reference signal slot, forming, at the first radio node, a modified position reference signal based on the initial position reference signal, wherein the modified position reference signal has a reduced probability of conflicting with a further position reference signal transmitted by either the second radio node or a further radio node, transmitting, from the first radio node, the modified position reference signal to the second radio node via a side link channel.

### FIELD

The present invention relates to a method of a first radio node for physical resource conflict avoidance in a side link resource pool between at least one position reference signal transmitted by the first radio node, and an associated method of a second radio node, and associated radio nodes, systems, computer program elements, and non-transitory computer readable media.

### BACKGROUND INFORMATION

Connected mobility is the subject of a variety of communication standards such as IEEE 802.11p/bd and 3GPP LTE/NR V2X (shortened in this specification to “V2X”). Two scenarios are considered for V2X—that User Equipment (UE) can be within communication range of a base station (BS) such as an evolved-Node BS (eNB) or a 5G-NR-Node BS (gNB), or out of communication range. Another scenario is that a proportion of the UEs that are connected together may be connected to the network, and the remainder of the UEs that are connected together may be out of network coverage. This is referred to as partial out of coverage.

Typically, when a UE (for example, UE mounted in a vehicle) is in coverage, the UE can be configured to perform sidelink communication with other UEs in range. In this case, resource allocation, data control, and communication procedures are controlled by the UE. In the case that a UE is out of coverage of, for example, EUTRA or 5G-NR cells, the UE is pre-configured with mandatory configuration for autonomous communication using the sidelink. In example, a UE can be pre-configured with a number of out-of-coverage frequencies. As an example, the out-of-coverage frequencies may include the Intelligent Transport System (ITS) frequencies.

In order that UEs can select sidelink resources, V2X provides for two operation modes for performing resource assignment. Mode one is controlled by the network. UEs are either dynamically granted sidelink resources that they request via the network, or are periodically configured with semi-persistent sidelink resources. Mode two enables UEs to select their resources autonomously based on respective needs of each UE from configured (or pre-configured) time and frequency resources referred to as shared resource pools.

Typically, when a UE (for example, UE mounted in a vehicle) is in coverage, the UE can be configured to perform sidelink communication with other UEs in range. In this case, resource allocation, data control, and communication procedures are controlled by the UE. In the case that a UE is out of coverage of, for example, EUTRA or 5G-NR cells, the UE is pre-configured with mandatory configuration for autonomous communication using the sidelink. In example, a UE can be pre-configured with a number of out-of-coverage frequencies. As an example, the out-of-coverage frequencies may include the Intelligent Transport System (ITS) frequencies.

V2X mode one requires the UEs to have network coverage. Mode two may be configured during a time when the UEs possess network coverage. When at least one UE is out of network coverage, mode two is, for example, automatically selected enabling at least one UE to select its own sidelink resources from the preconfigured shared resource pool.

FIG. 1 schematically illustrates an example of a radio network 8. In this example, the network comprises a “V2X” configured sidelink utilising mode 1 and mode 2, although it will be appreciated that the scenario of FIG. 1 may be extended to other radio standards using a sidelink between radio nodes that are out of coverage.

Region 10 is outside of network coverage provided by a BS. Region 12 is a region of partial coverage. Region 14 is in coverage. UE1 is a radio node that communicates with UE2 via a sidelink channel in mode 2, for example. UE3 communicates from the region of partial coverage to an out-of-coverage UE4 via the sidelink channel in Mode 2. UE5 communicates with UE6 via a sidelink channel in mode 1, as configured by control information Uu from the BS.

Identifying the position of a radio node with respect to another radio node is of interest in many scenarios. Wireless standards such as 3GPP Release 16 enable the UE to be configured with a downlink Position Reference Signal (PRS) having a high resource element (RE) density that is suitable for positioning calculations. The patterns of the PRS are referred to as combs, and are typically defined by the distance between two PRS REs, and an offset over time. Positioning approaches in 3GPP mobility scenarios may, however, be further improved.

### SUMMARY

According to a first aspect of the present invention, there is provided a method of a first radio node for physical resource conflict avoidance in a side link resource pool between at least one position reference signal transmitted by a first radio node and a further position reference signal transmitted by either the second radio node, or a further radio node.

According to an example embodiment of the present invention, the method includes:
obtaining, at the first radio node, an initial position reference signal comprising a plurality of resource elements arranged in a predetermined pattern within a side link position reference signal (SPRS) slot;
modifying, at the first radio node, the initial position reference signal to form a modified position reference signal, the modified position reference signal having a reduced probability of conflicting with a further position reference signal transmitted by either the second radio node or the further radio node; and
transmitting, from the first radio node, the modified position reference signal to a second radio node via at least one side link channel.

This enables the provision of position determination between at least two radio nodes when transmitting position reference signals via the sidelink resource pool. In other words, it is possible for two radio nodes to autonomously engage in position determination via the sidelink resource pool without the involvement of a coordinating base station (BS or gNB), for example. This solves the problem that, in uncoordinated PRS operation, at least two UEs can pick the same offset for transmitting the same PRS pattern, resulting in an allocation of overlapping PRS resources. Thus, a problem that the sidelink PRS cannot be resolved, or the accuracy of the positioning when using a sidelink PRS between UE1 and UE2 is degraded, is solved. This improves the positioning performance when positioning using the sidelink resource pool without recourse to additional signalling between radio nodes to agree the PRS signal offset in advance.

According to a second aspect of the present invention, there is provided a method of a second radio node for physical resource conflict avoidance in a side link resource pool between at least one position reference signal transmitted from a first radio node, wherein the second radio node is configured to compute its position relative to at least the first radio node. According to an example embodiment of the present invention, the method comprises:
transmitting, from the second radio node to the first radio node, a position reference signal request;
receiving, at the second radio node from the first radio node via at least one side link channel, at least one modified position reference signal, the at least one modified position reference signal having a reduced probability of conflicting with a further position reference signal transmitted by either the second or a further radio node, wherein the at least one modified reference signal is based on an initial position reference signal comprising a plurality of resource elements arranged in a predetermined pattern within a side link position reference signal (SPRS) slot.

According to a third aspect of the present invention, there is provided a first radio node, comprising a radio modem, a non-transitory computer readable media comprising machine readable instructions, and a processor configured to load and to execute the machine readable instructions to cause the first radio node to execute the steps according to the method of the first aspect of the present invention or its embodiments, and thus to transmit a modified position reference signal to a second radio node via at least one side link channel.

According to a fourth aspect of the present invention, there is provided a second radio node, comprising a radio modem, non-transitory computer readable media comprising machine readable instructions; and a processor configured to load and to execute the machine readable instructions to cause the second radio node to execute the steps according to the method of the second aspect or its embodiments.

According to a fifth aspect of the present invention, there is provided a system for radio communication, comprising a radio node and a second radio node. The second radio node is configured to transmit, from a second radio node to the first radio node, a position reference signal request. The first radio node is configured to obtain, at the first radio node, an initial position reference signal comprising a plurality of resource elements arranged in a predetermined pattern within a side link position reference signal (SPRS) slot. The first radio node is configured form a modified position reference signal based on the initial position reference signal, wherein the modified position reference signal has a reduced probability of conflicting with a further position reference signal transmitted by either the second radio node or a further radio node. The first radio node is configured to transmit the modified position reference signal to the second radio node via at least one side link channel. The second radio node is configured to receive, at the second radio node from the first radio node via at least one side link channel, at least one modified position reference signal, the at least one modified position reference signal having a reduced probability of conflicting with a further position reference signal transmitted by either the second radio node or a further radio node, wherein the at least one modified reference signal is based on an initial position reference signal comprising a plurality of resource elements arranged in a predetermined pattern within a side link position reference signal (SPRS) slot.

According to a sixth aspect of the present invention, there is provided a method for physical resource conflict avoidance when transmitting at least one position reference signal in a radio communication system comprising a first radio node and at least a second radio node. According to an example embodiment of the present invention, the method comprises:
transmitting, from a second radio node to the first radio node, a position reference signal request;
obtaining, at a first radio node, an initial position reference signal comprising a plurality of resource elements arranged in a predetermined pattern within a side link position reference signal (SPRS) slot;
forming, at the first radio node, a modified position reference signal based on the initial position reference signal, wherein the modified position reference signal has a reduced probability of conflicting with a further position reference signal transmitted by either the second radio node or a further radio node; and
transmitting, from the first radio node, the modified position reference signal to the second radio node via at least one side link channel; and
receiving, at the second radio node from the first radio node via at least one side link channel, at least one modified position reference signal, the at least one modified position reference signal having a reduced probability of conflicting with a further position reference signal transmitted by either the second radio node or the further radio node, wherein the at least one modified reference signal is based on an initial position reference signal comprising a plurality of resource elements arranged in a predetermined pattern within a side link position reference signal (SPRS) slot.

According to a seventh aspect of the present invention, there is provided computer program element comprising machine readable instructions which, when loaded and executed by a processor, cause the processor to perform the method according to the first aspect of the present invention, or its embodiments.

According to an eighth aspect of the present invention, there is provided a computer program element comprising machine readable instructions which, when loaded and executed by a processor, cause the processor to perform the method according to the second aspect of the present invention, or its embodiments.

According to a ninth aspect of the present invention, there is provided a non-transitory computer readable medium comprising the machine readable instructions according to the seventh or eighth aspect of the present invention.

According to a tenth aspect of the present invention, there is provided a vehicle, comprising a radio node according to the third or fourth aspects of the present invention.

The example embodiments of the present invention discussed herein may be applied to location-finding between at least two radio nodes according to 5G use cases discussed in TR 22.872, such as location-based services using accurate positioning between bicycles, industry-related use cases such as waste management and collection, e-Health related use cases such as locating medical equipment in hospitals, emergency-services related applications, road-related use cases such as road-user charging, rail and maritime-related use cases, such as freight tracking, and aerial-related use-cases such as unmanned aerial vehicle missions and operations.

### BRIEF DESCRIPTION OF THE DRAWINGS

Exemplary embodiments of the present invention are depicted in the figures, which are not to be construed as limiting the present invention, and are explained in greater detail below.

FIG. 1 schematically illustrates an example of a “V2X” configured system comprising a sidelink that can be configured into mode 1 and mode 2.

FIG. 2 schematically illustrates an example of time and frequency resource configuration of the sidelink in mode 2.

FIG. 3 schematically illustrates colliding resources of a sidelink position reference signal (SPRS) from an RX UE perspective.

FIG. 4 schematically illustrates colliding resources of a sidelink position reference signal from a TX UE perspective.

FIG. 5 schematically illustrates during different Time of Arrival (ToA) measurements at one RX UE.

FIG. 6 schematically illustrates an enlarged view of an RX slot boundary illustrated in FIG. 5.

FIG. 7 schematically illustrates a method of a first radio node according to the first aspect.

FIG. 8 schematically illustrates an example of a position reference signal pattern within a slot.

FIG. 9 schematically illustrates an example of a table defining the offset of a PRS pattern for different numbers of subcarriers within the PRS comb.

FIG. 10 schematically illustrates a method of a second radio node according to the first aspect.

FIG. 11 schematically illustrates a first or second radio node according to the third or fourth aspects, respectively.

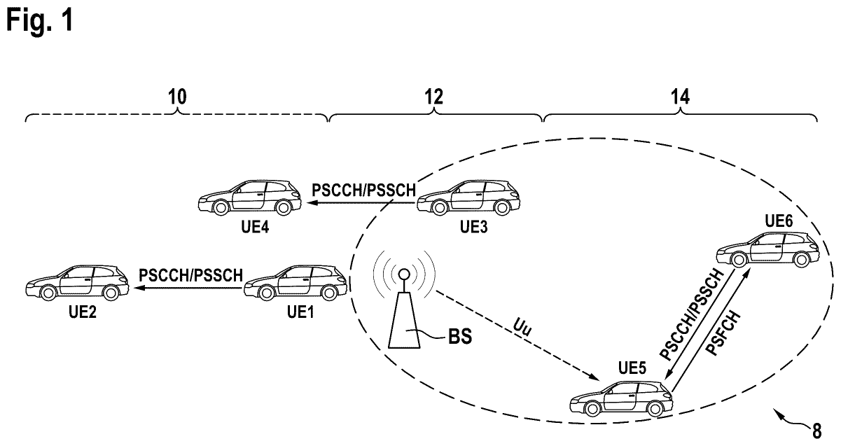

### DETAILED DESCRIPTION OF EXAMPLE EMBODIMENTS

The radio standard 5G New Radio (5GNR) provides for a network comprising a next generation node base station (gNB) and a set of User Equipment (UE1, UE2 . . . ). The gNB is used for controlling of communicating data to some, or all of the UEs via the Uu interface. The Uu interface may be considered to be a communication link between a gNB and another network terminal UE. In examples, the UE terminal (also referred to herein as a radio node) may be an IoT device, a vehicular infrastructure element, an industrial automation component, or an industrial infrastructure element. Examples of vehicular infrastructure elements are traffic lights, and streetlights. Examples of an industrial infrastructure element are robots or industrial machines. The UE terminal may be a mobile telephone, laptop computer, tablet, smartwatch, or the like. The UE terminal may be embodied within a vehicle such as an automobile, heavy goods vehicle, bicycle, and the like.

The 3GPP standard provides for the transmission of signals between first and second radio nodes enabling the second radio node to determine its position relative to a first radio node, for example. The signals are typically referred to as “combs” owing to their structure in frequency and time. The first radio node UE1 may be requested by the second radio node UE2 to transmit a position reference signal (PRS) having a comb structure known at the second radio node UE2. When the second radio node UE2 receives the requested PRS from the first radio node, a decoding technique such as downlink angle of departure (DL-AoD), uplink angle of arrival (UL-AoA), Round Trip Time (RTT), downlink Time of Arrival (DL-ToA) or uplink Time of Arrival (UL-ToA) may be applied by the second radio node UE2 to the PRS transmitted by the first radio node UE1. This enables the second radio node UE2 to determine its position relative to the first radio node UE1.

Current implementations of positioning using the PRS only support positioning for classical cellular scenarios, such as positioning between the gNB (base station, BS) and mobile radio nodes UE. Vehicular and industrial applications, when out of coverage (or in partial coverage) of a gNB (base station, BS) require inter-UE positioning without involving the gNB. The present specification details an approach for using the PC5 sidelink to support inter radio-node positioning.

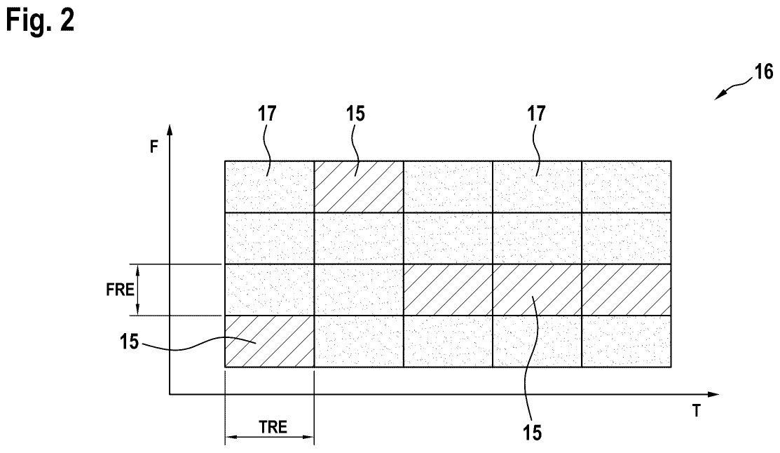

FIG. 2 schematically illustrates an example of time and frequency resource configuration of the sidelink in mode 2.

The sidelink resource allocation 16 in mode 2 is divided into frequency resource blocks (ranges of subchannels) FRE and time slots TRE. In an example, a subset 17 of the sidelink resource allocation in mode 2 is configured by the gNB. Another subset 15 of the resource allocation is dedicated to autonomously used resources accessed by the radio nodes UE. In an example, one or more UEs may use semi periodic scheduling of the sidelink resource allocation 16 to contend for sidelink resources. In mode 2, resources can be allocated as a one-shot transmission, where the UE transmits into the gNB controlled resource or the autonomously allocated resource as a MAC-PDU because available.

In another example, configured sidelink resources may enable a UE to transmit multiple MAC-PDUs on multiple transmission opportunities.

3GPP, release 16, proposed Position Reference Signal configurations, for example, defining the structure of a PRS signal during the downlink and/or uplink between UE and a gNB (BS). The Position Reference Signal configuration also defines on which OFDM symbol and subcarriers the PRS may be found. A PRS positioning frequency layer is defined as a collection of PRS resource sets with each PRS resource set defining a collection of PRS resources. When applied to localisation between a radio node such as a gNB and a radio node such as item of user equipment UE5, one or more downlink Position Reference Signals are used at UE5 transmitted from the gNB (BS). The 3GPP release 16 PRS has a high resource element density having a diagonal or staggered PRS pattern and correlation properties that are better than existing reference signals.

The improved PRS signal of 3GPP release 16 cannot be mapped to the problem of position determination between first and second radio nodes UE1, UE2 via the sidelink in mode 2. In Base Station (gNB) coordinated positioning, the base stations can coordinate which comb patterns from the PRS set, with which offset, are used by the base station, and associated UEs. This prevents a given UE from experiencing a collision of two different PRS at the same time. However, to apply the PRS directly to position determination between first UE1 and second UE2 radio nodes using the sidelink resource pool is problematic because the sidelink resource pool resource selection is performed between at least two UEs autonomously, usually using a distributed contention protocol such as semi persistent scheduling. Therefore, at least two UEs can pick the same offset for transmitting the same PRS pattern, for example. This results in an allocation of overlapping PRS resources. Thus, the sidelink PRS cannot be resolved between UE1 and UE2, degrading the positioning performance.

Furthermore, the PRS comb structure defines the spacing of the PRS for a distinct user. This defines how many users can share one PRS block. There is, therefore, a trade-off between the number of users engaging in positioning using a number of PRS patterns using the same sidelink resource pool, and the performance of the ranging itself.

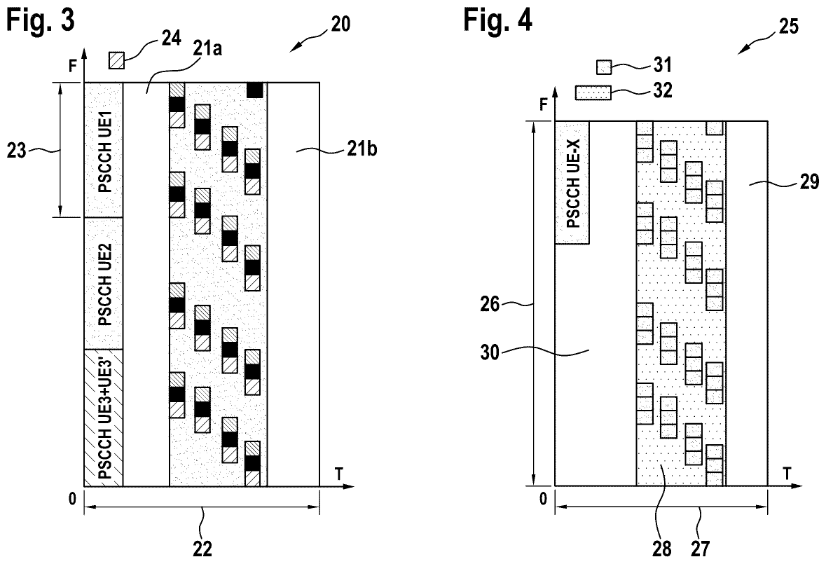

FIG. 3 schematically illustrates colliding resources of a sidelink position reference signal (SPRS) from an RX UE perspective.

In FIG. 3, region 20 is a time-frequency plot representing of a portion of the resource grid of a sidelink resource pool from the RX perspective of a first radio node UE1. The subchannel index illustrated along direction 23 and the time (slot) index indicated along direction 22. An OFDM slot of multiplexed SPRS from three radio nodes UE1, UE2, and UE3 is illustrated. Regions 21a and 21b of the sidelink resource pool are areas with data symbols (that are not used for position determination), a gap, or blank symbols. PSCCH UE1 and PSCCH UE2 are the Physical Sidelink Control Channels for UE1 and UE2. The hatched symbols 24 represent a colliding SPRS.

FIG. 4 schematically illustrates colliding resources of a sidelink position reference signal from a TX UE perspective.

In FIG. 4, region 20 is a time-frequency plot representing of a portion of the resource grid of a sidelink resource pool from the TX perspective of a first radio node UE1, with the allocated l subchannels of the sidelink resource pool denoted along direction 26 and the OFDM slot index of the multiplexed SPRS denoted along direction 27. Region 28 comprises, from the TX perspective, possible data symbols of the sidelink resource pool with blanked resource elements, denoted by shading 32. Possible blanked resource elements are denoted with texture 31. Regions 29 and 30 represent data symbol of the sidelink resource pools (these are outside slots of the sidelink resource pool used for PRS transmission).

Turning briefly to FIG. 8, which schematically illustrates an example of a position reference signal pattern within a slot, a time-frequency plot 70 illustrating a portion of a sidelink resource pool comprising an SPRS according to embodiments discussed herein. Along the time axis, 14 OFDM symbols S1-14 are denoted. Along the frequency axis, a plurality of subcarriers K0-N are denoted. Resource Elements (RE) are denoted as the dark-coloured squares in the time-frequency plot 70. A Resource Element offset (REoffset) is a displacement of a resource element (or a plurality of resource elements forming a PRS comb signal) according to the subcarrier index from an origin subcarrier index of the sidelink resource pool. In FIG. 8, the resource elements comprising the comb pattern of OFDM symbol 6 have an REoffset C of 2. The resource elements comprising the comb pattern of OFDM symbol 7 have an REoffset D of 1. The resource elements comprising the comb pattern of OFDM symbol 8 have an REoffset E of 3.

The offset of the SPRS comb from a reference subcarrier (resource element) for each OFDM symbol enables multiplexing of different users within the same positioning window. In scenario where the SPRS is defined, for each UE, from the base station BS (gNB), the offset is also defined by the base station BS. According to embodiments, it is proposed that a UE1 (the first radio node UE1) can modify an initial reference signal to reduce, or eliminate, the risk that the PRS transmitted from the first UE1 will collide with PRS signals transmitted by further UEs.

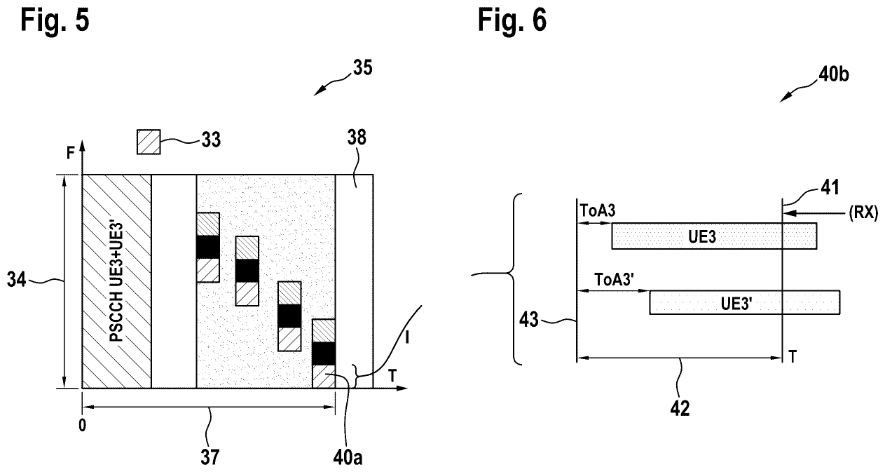

FIG. 5 schematically illustrates during different Time of Arrival (ToA) measurements at one RX UE3 in the scenario of FIGS. 3 and 4. The duration of one slot in time is denoted by interval 37, and the frequency range of a subchannel is denoted by interval 34. A 1 symbol gap is denoted by region 38. SPRS resource elements that collide are denoted by the hatched squares 33. The SPRS resource element 41a is enlarged in FIG. 6.

FIG. 6 schematically illustrates an enlarged view of the time-frequency space 40b during different Time of Arrival (ToA) measurements at UE3. The RX slot boundary is denoted by interval 42. The slot start is denoted by interval line 43. Colliding resources at, for example, a further radio node UE3 may be decodable using successive decoding, such that special codes applied to the individual SPRS symbols enable separation of the individual SPRS symbols.

According to a first aspect, there is provided a method 50 of a first radio node UE1 for physical resource conflict avoidance in a side link resource pool between at least one position reference signal transmitted by a first radio node UE1 between the first radio node UE1 and at least a second radio node and a further position reference signal transmitted by either the second radio node, or a further radio node, the method comprising:
obtaining (51), at the first radio node UE1, an initial position reference signal comprising a plurality of resource elements arranged in a predetermined pattern within a side link position reference signal (SPRS) slot;
modifying (52), at the first radio node UE1, the initial position reference signal to form a modified position reference signal, the modified position reference signal having a reduced probability of conflicting with a further position reference signal transmitted by either the second radio or the further radio node; and
transmitting (53), from the first radio node UE1, the modified position reference signal to a second radio node via at least one side link channel.

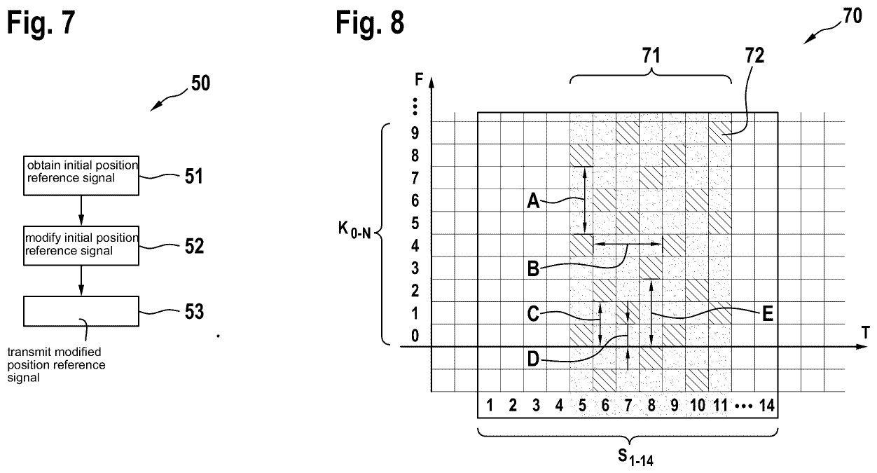

FIG. 7 schematically illustrates a method 50 of a first radio node UE1 according to the first aspect.

FIG. 8 schematically illustrates an example of a position reference signal pattern within a slot S1-14, according to an example. The interval 71 is the number of OFDM symbols used to transmit the position reference signal (PRS) L_{PRS}. The resource element 72 is a comb element forming part of a position reference signal.

The initial position reference signal may, for example, be an SPRS comb as defined according to 3GPP Release 16, as in TS 138.211, section 7.4.1.7, which is hereby incorporated by reference, although this is not essential.

According to an embodiment of the first aspect, modifying, at the first radio node UE1, the initial position reference signal to form a modified position reference signal further comprises:
forming the modified position reference signal based on an implicitly indicated position derived from at least one item of side link control information (SCI) corresponding to the side link position reference signal (SPRS).

The offsetting of the SPRS comb generated by forming the modified position reference signal enables the multiplexing of different users within the same positioning window. FIG. 8 illustrates one version of the offsetting. To avoid needing to perform additional signalling in the sidelink control information SCI defining how the modified position reference signal is generated based on the initial position reference signal, this embodiment provides implicit indication based on the SCI subcarrier position. In this example, the SCI (such as the first stage of the SCI) is limited to one or more subchannels K0-N, where the SCI is confined to these subchannels for every SCI associated with an SPRS slot.

Optionally, the total number of subchannels allocated for a sidelink resource pool is divided across a plurality of separate subcarrier locations, and the transmission of a SCI on each of these locations can be implicitly read by a receiving UE as corresponding to a preconfigured SPRS transmission comb offset (modification of the initial position reference signal). Optionally according to an embodiment of the first aspect, the side link resource pool comprises a set of contiguous subcarriers.

### Solution 1: PRS Offset Indication by Implicit SCI Subchannel Selection

According to an embodiment of the first aspect, modifying, at the first radio node UE1, the initial position reference signal to form a modified position reference signal further comprises:
identifying one or more reference coordinates of one or more subchannels in the side link resource pool corresponding to the one or more side link position reference signal (SPRS) slots; and
forming the modified position reference signal as a function of the one or more reference coordinates.
A first radio node UE1 can implicitly obtain an offset of the PRS (and thus the transmission of a modified position reference signal) by identifying a reference coordinate based on the subchannel position of the SCI.
According to an embodiment of the first aspect, the side link resource pool is separated into at least a first subset and a second subset of subchannels, wherein the first subset and a second subset have a different, and non-overlapping, frequency coordinates. The method further comprises:
identifying a first reference coordinate of the first subset of subchannels in the side link resource pool;
identifying a second reference coordinate of the second subset of subchannels in the side link resource pool;
forming a first modified position reference signal as a function of the initial position reference signal and the first reference coordinate, and forming a second modified position reference signal as a function of the initial position reference signal and the second reference coordinate; and
transmitting the first and second modified position reference signals.

In the example above, a first UE (radio node) and a second UE (radio node) signal non-overlapping SCI locations as illustrated by the location of PSSCH1 and PSSCH2 of FIG. 3, which are examples of first and second reference coordinates from the first and second SCI.

According to an embodiment, the offset of the initial position reference signal for a PRS comb index K_{comb}^{PRS} selected from the group of 2, 4, 6, or 12 is a function of a symbol number as defined by a corresponding row of table 1, where l denotes the OFDM symbol index relative to a reference symbol.

TABLE 1
offset of resource elements from the reference symbol based
on OFDM symbol number and PRS comb size (REoffset)

| | Symbol Number in the Downlink PRS Resource Allocation | | | | | | | | | | | |
|---|---|---|---|---|---|---|---|---|---|---|---|---|
| | (l − lₛₜₐᵣₜ^{PRS}) = 0, . . . , L_{PRS} − 1 | | | | | | | | | | | |
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

In an example, the first radio node UE1 identifies that a second radio node UE2 has transmitted PSCCH2, and the first subchannel position of the SCI transmitted by the second radio node UE2 is the reference coordinate. Other parts of the SCI could be used to generate the reference coordinate. An initial position reference signal is generated using a predetermined PRS signal definition and a comb index K_{comb}^{PRS}. One example of a predetermined PRS signal definition is as given in 3GPP Release 16, as in TS 138.211, section 7.4.1.7, which is hereby incorporated by reference. The resource elements of the sidelink resource pool occupied by comb signals are computed to form the initial position reference signal. Each resource element of the initial position reference signal is offset using a resource element offset variable. One example of a resource element offset variable is according to Table 1.

For PRS having a given comb index, the frequency offset to be applied to resource elements of the PRS comb at each OFDM symbol are obtained, and applied to the resource elements of the initial position reference signal to form the modified position reference signal. When the modified position reference signal is transmitted by the first radio node UE1, there is a reduced risk of collision with a position reference signal transmitted by either the second radio node or another radio node UE, because the offset of the modified position reference signal relative to the initial position reference signal is based on the first subchannel position of the SCI acting as the reference coordinate.

According to the embodiments discussed above, different SCI allocations are implicit signals used to enable different PRS location, thus reducing the collision chances. No additional signalling is required, to indicate location of the comb pattern transmitted by one of more of the radio nodes UE1, UE2, etc.

### Solution 2: Transmission Blanking for Scheduled SPRS

According to an embodiment of the first aspect, the method further comprises:
detecting, at the first radio node UE1, a request from the second or the further radio node to transmit a preconfigured side link position reference signal at a preconfigured location of the side link resource pool; and wherein modifying, at the first radio node UE1, the initial position reference signal to form a modified position reference signal further comprises:
identifying at least one conflicting resource element of the initial position reference signal, wherein the transmission of the least one resource element would conflict with a corresponding resource element of the preconfigured side link position reference signal to be transmitted by the second or the further radio node; and
removing at least one conflicting resource element from the initial position reference signal to form the modified position reference signal.
According to an embodiment of the first aspect, the method further comprises:
muting, at the first radio node UE1, at least one of the resource elements in the initial position reference signal.

According to this embodiment, the modified position reference signal is formed by detecting that a further radio node UE3 in the network is preparing to transmit a position reference signal. Because the position reference signal of the further radio node UE3 is preconfigured, and thus also known at the first radio node UE1, the first radio node UE1 searches, prior to transmitting in an OFDM slot, for conflicting resource elements between the initial position reference signal to be transmitted by the first radio node UE1 and the position reference signal of the further radio node UE3.

When the first radio node UE1 finds a portion of its position reference signal will conflict with the preconfigured reference signal to be transmitted by the further radio node UE3, the first radio node UE1 forms the modified position reference signal to be transmitted by the first radio node UE1 in a way that reduces or removes conflict with the preconfigured reference signal. For example, PRS symbols for transmission by the first radio node UE1 can be entirely removed or muted from the initial reference signal of the first radio node UE1 to form the modified reference signal. Alternatively, a proportion (such as 20%, 40%, 60%, 80%) of conflicting PRS symbols for transmission by the first radio node UE1 can be removed or muted, to form the modified reference signal. This reduces the degree to which the position reference signal transmitted in the sidelink resource pool by the further radio node UE3 will collide with the modified reference signal transmitted by the first radio node UE1.

### Solution 3: SPRS Signal Generation of Overbooked SPRS Window Using Codes

According to an embodiment of the first aspect, the method further comprises:
generating, at the first radio node UE1, an orthogonal code uniquely identifying the first radio node UE1;
modifying, at the first radio node UE1, the initial position reference signal as a function of the orthogonal code identifying the first radio node, to thus form the modified position reference signal.

In some situations, the first UE1 and second UE2 radio nodes may simultaneously select the same SCI resources. For example, the SCI resources and the SPRS resources of the first UE1 and second UE2 radio nodes may collide (which can be detected by both first UE1 and second UE2 radio nodes if an SCI collision is detected, or when SCI decoding fails. In another example, successive decoding of the colliding SCIs may reveal the presence of two overlapping SPRS sequences. In this case, correlation with the SPRS will result in two (or more) Times of Arrival for the two (or more) SPRS transmitters, as shown in FIGS. 5 and 6.

According to an embodiment of the first aspect, the wherein the orthogonal code uniquely identifying the first radio node UE1 is designated at the first radio node UE1 using a position reference signal sequence identity (NPRSID).

Therefore, the problem of overbooking illustrated in FIGS. 5 and 6 can be overcome by applying a unique code to define the subcarriers used for the PRS per user. The initial reference signal at each radio node is modified by applying the code to the initial reference signal. According to an embodiment of the first aspect, the orthogonal code uniquely characterising the first radio node UE1 is a Gold sequence. According to an embodiment of the first aspect, the position reference signal sequence identity (NPRSID) is selected using the cyclic redundancy check code of a PSCCH transmitted by the first radio node UE1.

In other words, each UE indicates which Gold sequence was used to encode the PRS using the PRS sequence identity NPRSID according to TS 38.211 section 7.4.1.7.2, which is hereby incorporated by reference. The NPRSID can take values between 0, . . . , 4095 (12 bits are required to represent the ID, which may be signalled in the SCI).

In an embodiment, the NRPRSID is selected based on the PSCCH CRC as done for the DM-RS (demodulation reference signal) defined in TS 38.211, which is hereby incorporated by reference. Accordingly, N_{ID}=N_{ID}^{X}mod2¹², where the quantity N_{ID}^{X} is the decimal representation of the cyclic redundancy check of the PSCCH associated with the PSCCH according to N_{ID}^{X}=Σᵢ₌₀^{L-1}ρᵢ·2^{L-1-i} with ρ and L given by clause 7.3.2 in TS 38.212, which is hereby incorporated with reference. Therefore, when generating the modified position reference signal, the signalling overhead may also be reduced with reference to the PSCCH CRC of the radio nodes.

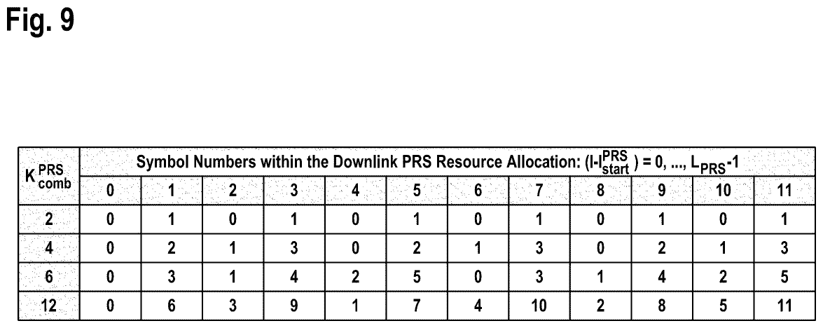

FIG. 9 schematically illustrates an example of a table defining the offset of a PRS pattern for different numbers of subcarriers within the PRS comb.

According to an embodiment of the first aspect, the method further comprises:
preconfiguring the side link resource pool based on a configuration obtained from a gNB.

According to an embodiment of the first aspect, the first and second radio nodes are configured to communicate using the sidelink defined by mode 2 of 3GPP LTE/NR V2X.

Computing radio node position using the modified position reference signal

According to the second aspect, there is provided a method 55 of a second radio node for physical resource conflict avoidance in a side link resource pool between at least one position reference signal transmitted from a first radio node UE1 between the first radio node UE1 and at least a second radio node, wherein the second radio node is configured to compute its position relative to at least the first radio node UE1, comprising:

transmitting 56, from a second radio node to a first radio node UE1, a position reference signal request;
receiving 57, at the second radio node from the first radio node UE1 via at least one side link channel, at least one modified position reference signal, the at least one modified position reference signal having a reduced probability of conflicting with a further position reference signal transmitted by either the second or a further radio node, wherein the at least one modified reference signal is based on an initial position reference signal comprising a plurality of resource elements arranged in a predetermined pattern within a side link position reference signal (SPRS) slot.

When the second radio node UE2 receives the modified reference signal transmitted via the sidelink resource pool from the first radio node UE1, the second radio node UE2 performs direction-finding on the received modified reference signal as would be understood by a person skilled in the art, such as RTT analysis, ToA analysis, or DoA analysis. Because the received modified reference signal has a lower, or zero, probability of having collided with another position reference signal, the position of the second radio node UE2 relative to the first radio node UE1 can be determined with greater reliability, or accuracy.

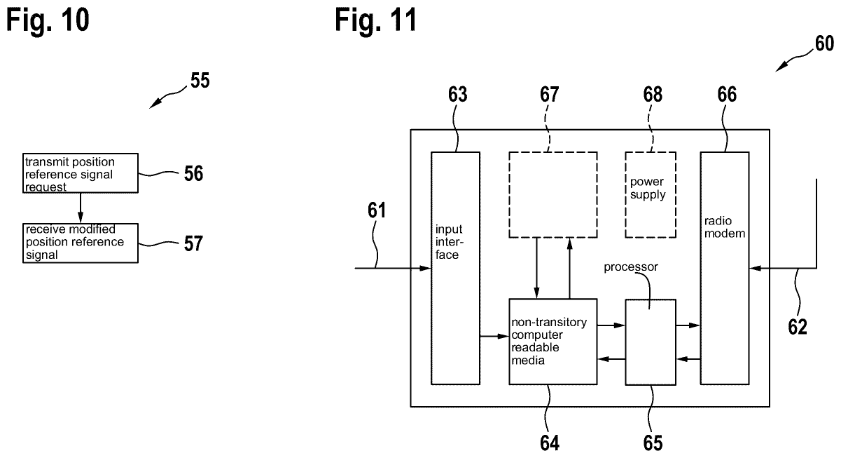

FIG. 10 schematically illustrates a method 55 of a second radio node.

An embodiment of the second aspect comprises calculating the position of the second radio node relative to the first radio node UE1 using the modified position reference signal.

An embodiment of the second aspect comprises:
detecting, at the second radio node, a side link control information collision; and
upon detection of a side link control information collision, performing successive decoding at the second radio node on the detected side link control information collision, to thereby detect at least two side link position reference signal sequences transmitted from first and third radio nodes, respectively.

An embodiment of the second aspect comprises obtaining, from the side link position reference signal sequences transmitted from first and third radio nodes, a position of the second radio node relative to the first radio node UE1, and a position of the second radio node relative to the third radio node.

An embodiment of the second aspect comprises calculating the position of the second radio node relative to the first radio node UE1 using one of: downlink angle of departure or round-trip time.

### Radio Node

FIG. 11 schematically illustrates a first or second radio node according to the third or fourth aspects, respectively. Reference numerals assigned in FIG. 11 may denote elements of either the first, or second radio node.

According to a third aspect, there is provided a first radio node 60, comprising a radio modem 66, a non-transitory computer readable media 64 comprising machine readable instructions, and a processor 65 configured to load and to execute the machine readable instructions to cause the first radio node to execute the steps according to the method of the first aspect or its embodiments, and thus to transmit a modified position reference signal to a second radio node via at least one side link channel. The first radio node 60 may comprise an input interface 63 configured to obtain input data, for example MAC PDUs. The radio node 60 may comprise a power supply 68. The radio node may comprise an antenna (62) coupled to the radio modem 66. The first radio node may support may support node to node, internet of things, and V2X communications.

According to a fourth aspect, there is provided a second radio node, comprising a radio modem, non-transitory computer readable media comprising machine readable instructions; and a processor configured to load and to execute the machine readable instructions to cause the second radio node to execute the steps according to the method of the second aspect or its embodiments. The second radio node may be substantially as illustrated in FIG. 11, or contain design variations. The second radio node may support may support node to node, internet of things, and V2X communications.

### Radio Communication System

According to a fifth aspect, there is provided a system for radio communication, comprising a radio node and a second radio node. The second radio node is configured to transmit, from a second radio node to the first radio node UE1, a position reference signal request. The first radio node UE1 is configured to obtain, at the first radio node UE1, an initial position reference signal comprising a plurality of resource elements arranged in a predetermined pattern within a side link position reference signal (SPRS) slot. The first radio node UE1 is configured form a modified position reference signal based on the initial position reference signal, wherein the modified position reference signal has a reduced probability of conflicting with a further position reference signal transmitted by either the second or a further radio node. The first radio node UE1 is configured to transmit the modified position reference signal to the second radio node via at least one side link channel. The second radio node is configured to receive, at the second radio node from the first radio node UE1 via at least one side link channel, at least one modified position reference signal, the at least one modified position reference signal having a reduced probability of conflicting with a further position reference signal transmitted by either the second or the further radio node, wherein the at least one modified reference signal is based on an initial position reference signal comprising a plurality of resource elements arranged in a predetermined pattern within a side link position reference signal (SPRS) slot.

According to a sixth aspect, there is provided a method for physical resource conflict avoidance when transmitting at least one position reference signal in a radio communication system comprising a first radio node UE1 and at least a second radio node, wherein the method comprises:
transmitting, from a second radio node to the first radio node UE1, a position reference signal request;
obtaining, at a first radio node UE1, an initial position reference signal comprising a plurality of resource elements arranged in a predetermined pattern within a side link position reference signal (SPRS) slot;
forming, at the first radio node UE1, a modified position reference signal based on the initial position reference signal, wherein the modified position reference signal has a reduced probability of conflicting with a further position reference signal transmitted by either the second or a further radio node; and
transmitting, from the first radio node UE1, the modified position reference signal to the second radio node via at least one side link channel; and
receiving, at the second radio node from the first radio node UE1 via at least one side link channel, at least one modified position reference signal, the at least one modified position reference signal having a reduced probability of conflicting with a further position reference signal transmitted by either the second or a further radio node, wherein the at least one modified reference signal is based on an initial position reference signal comprising a plurality of resource elements arranged in a predetermined pattern within a side link position reference signal (SPRS) slot.

According to a tenth aspect, there is provided a vehicle, comprising a radio node according to the third or fourth aspects.

According to a seventh aspect, there is provided computer program element comprising machine readable instructions which, when loaded and executed by a processor, cause the processor to perform the method according to the first aspect, or its embodiments.

According to an eighth aspect, there is provided a computer program element comprising machine readable instructions which, when loaded and executed by a processor, cause the processor to perform the method according to the second aspect, or its embodiments.

According to a ninth aspect, there is provided a non-transitory computer readable medium comprising the machine readable instructions according to the seventh or eighth aspect.

A radio node may, alternatively, be denoted a radio communications device. The examples provided in the drawings and described in the foregoing written description are intended for providing an understanding of the principles of this specification. No limitation to the scope of the present invention is intended thereby. The present specification describes alterations and modifications to the illustrated examples. Only the preferred examples have been presented, and all changes, modifications and further applications to these within the scope of the specification are desired to be protected.

1-28. (canceled)

29. A method of a first radio node for physical resource conflict avoidance in a side link resource pool between at least one position reference signal transmitted by the first radio node to at least a second radio node, and a further position reference signal transmitted by either the second radio node, or a further radio node, the method comprising the following steps:
obtaining, at the first radio node, an initial position reference signal including a plurality of resource elements arranged in a predetermined pattern within a side link position reference signal slot;
modifying, at the first radio node, the initial position reference signal to form a modified position reference signal, the modified position reference signal having a reduced probability of conflicting with the further position reference signal transmitted by either the second radio node or the further radio node; and
transmitting, from the first radio node, the modified position reference signal to the second radio node via at least one side link channel.

30. The method according to claim 29, wherein the modifying, at the first radio node, of the initial position reference signal to form a modified position reference signal further includes:
forming the modified position reference signal based on an implicitly indicated position derived from at least one item of side link control information corresponding to the side link position reference signal.

31. The method according to claim 29, wherein the modifying, at the first radio node, of the initial position reference signal to form a modified position reference signal further includes:
identifying one or more reference coordinates of one or more subchannels in the side link resource pool corresponding to the side link position reference signal slot; and
forming the modified position reference signal as a function of the one or more reference coordinates.

32. The method according to claim 29, wherein the side link resource pool is separated into at least a first subset and a second subset of subchannels, wherein the first subset and a second subset have a different, and non-overlapping, frequency coordinates, and the method further comprises:
identifying a first reference coordinate of the first subset of subchannels in the side link resource pool;
identifying a second reference coordinate of the second subset of subchannels in the side link resource pool;
forming a first modified position reference signal as a function of the initial position reference signal and the first reference coordinate, and forming a second modified position reference signal as a function of the initial position reference signal and the second reference coordinate; and
transmitting the first and second modified position reference signals.

33. The method according to claim 29, further comprising the following steps:
detecting, at the first radio node, a request from either the second or the further radio node to transmit a preconfigured side link position reference signal at a preconfigured location of the side link resource pool, and wherein the modifying, at the first radio node, of the initial position reference signal to form a modified position reference signal further includes:
identifying at least one conflicting resource element of the initial position reference signal, wherein the transmission of the least one resource element would conflict with a corresponding resource element of the preconfigured side link position reference signal to be transmitted by either the second or the further radio node; and
removing the at least one conflicting resource element from the initial position reference signal to form the modified position reference signal.

34. The method according to claim 33, further comprising:
muting, at the first radio node, at least one of the resource elements in the initial position reference signal.

35. The method according to claim 29, further comprising the following steps:
generating, at the first radio node, an orthogonal code uniquely identifying the first radio node; and
modifying, at the first radio node, the initial position reference signal as a function of the orthogonal code identifying the first radio node, to form the modified position reference signal.

36. The method according to claim 35, wherein the orthogonal code uniquely identifying the first radio node is designated at the first radio node using a position reference signal sequence identity.

37. The method according to claim 29, wherein forming the modified reference signal includes applying an offset to the initial position reference signal for a PRS comb index K_{comb}^{PRS} selected from a group of 2, 4, 6, or 12, wherein the offset is a function of a symbol number as defined by a corresponding row of the following table:

| | Symbol Numbers in the Downlink PRS Resource Allocation | | | | | | | | | | | |
|---|---|---|---|---|---|---|---|---|---|---|---|---|
| | (l − lₛₜₐᵣₜ^{PRS}) = 0, . . . , L_{PRS} − 1 | | | | | | | | | | | |
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

38. A method of a second radio node for physical resource conflict avoidance in a side link resource pool between at least one position reference signal transmitted from a first radio node to at least the second radio node, wherein the second radio node is configured to compute its position relative to at least the first radio node, the method comprising the following steps:
transmitting, from the second radio node to the first radio node, a position reference signal request; and
receiving, at the second radio node from the first radio node via at least one side link channel, at least one modified position reference signal, the at least one modified position reference signal having a reduced probability of conflicting with a further position reference signal transmitted by either the second radio node or a further radio node, wherein the at least one modified reference signal is based on an initial position reference signal comprising a plurality of resource elements arranged in a predetermined pattern within a side link position reference signal slot.

39. The method according to claim 38, further comprising:
calculating the position of the second radio node relative to the first radio node using the modified position reference signal.

40. The method according to claim 38, further comprising:
detecting, at the second radio node, a side link control information collision; and
upon detection of a side link control information collision, performing successive decoding at the second radio node on the detected side link control information collision, to thereby detect at least two side link position reference signal sequences transmitted from first and third radio nodes, respectively.

41. The method according to claim 40, further comprising:
obtaining, from the side link position reference signal sequences transmitted from first and third radio nodes, a position of the second radio node relative to the first radio node, and a position of the second radio node relative to the third radio node.

42. A first radio node, comprising:
a radio modem;
non-transitory computer readable media including machine readable instructions; and
a processor configured to load and to execute the machine readable instructions, the machine readable instructions being for physical resource conflict avoidance in a side link resource pool between at least one position reference signal transmitted by the first radio node to at least a second radio node, and a further position reference signal transmitted by either the second radio node, or a further radio node, the machine readable instructions, when executed by the first radio node, causing the first radio node to perform the following steps:
obtaining, at the first radio node, an initial position reference signal including a plurality of resource elements arranged in a predetermined pattern within a side link position reference signal slot,
modifying, at the first radio node, the initial position reference signal to form a modified position reference signal, the modified position reference signal having a reduced probability of conflicting with the further position reference signal transmitted by either the second radio node or the further radio node, and
transmitting, from the first radio node, the modified position reference signal to the second radio node via at least one side link channel.

43. A second radio node, comprising:
a radio modem;
non-transitory computer readable media including machine readable instructions; and
a processor configured to load and to execute the machine readable instructions, the machine readable instructions being for physical resource conflict avoidance in a side link resource pool between at least one position reference signal transmitted from a first radio node to at least the second radio node, wherein the second radio node is configured to compute its position relative to at least the first radio node, the machine readable instructions, when executed by the second radio node, causing the second radio node to perform the following steps:
transmitting, from the second radio node to the first radio node, a position reference signal request, and
receiving, at the second radio node from the first radio node via at least one side link channel, at least one modified position reference signal, the at least one modified position reference signal having a reduced probability of conflicting with a further position reference signal transmitted by either the second radio node or a further radio node, wherein the at least one modified reference signal is based on an initial position reference signal comprising a plurality of resource elements arranged in a predetermined pattern within a side link position reference signal slot.
